(19) United States
(12) Patent Application Publication
(10) Pub. No.: US 2010/0273429 A1
(43) Pub. Date: Oct. 28, 2010

(54) METHOD AND ARRANGEMENT FOR DETERMINING NON-LINEAR BEHAVIOR

(75) Inventor: Lukas F. Tiemeijer, Eindhoven (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., EINDHOVEN (NL)

(21) Appl. No.: 12/160,416

(22) PCT Filed: Jan. 5, 2007
(86) PCT No.: PCT/IB07/50039

§ 371 Date: Jul. 9, 2008

(30) Foreign Application Priority Data
Jan. 9, 2006 (EP) 06100156.0

(51) Int. Cl. H04B 17/00

(52) U.S. Cl. 455/67.11

(57) ABSTRACT

The present invention relates to a method of and arrangement for determining non-linear behavior of a device (40) under test, wherein the device (40) is excited by a test signal on relevant device terminals under different termination conditions and the emitted signals at the fundamental and harmonic frequencies are measured at the relevant device terminals. Then, calibration measurements taken on calibration standards of known impedance and linearity are performed to derive parameters needed to correct the raw data read by the measurement for cable loss and delay and for non-linear behavior of the measurement system. Finally, non-linear scattering or admittance parameters are extracted from the error corrected measurements taken at different excitation and termination conditions. Thereby, the non-linear behavior can be more accurately characterized, modeled and understood.

The present invention relates to a method and arrangement for determining non-linear behavior of a device under test, e.g. a radio frequency (RF) or microwave device.

Telecommunication or other RF or microwave appliances have been widely adopted by the general public. These appliances contain such RF or microwave components like mixers, low noise amplifiers, power amplifiers and the like. The design of such components often leads to huge problems and requires several design iterations, a main reason being the limited accuracy of RF models used, especially with respect to the description of the non-linear behavior thereof.

Conventional models are based on small signal measurements. Scattering (S) and Admittance (Y) parameters have proven their value to describe the behavior of linear networks where input and output frequencies are the same. However, if such models are used in non-linear (large-signal) operation, one can expect that they not always perform well in describing the hard non-linear behavior of a device under test, such as for example, an RF power transistor. To characterize non-linear networks conventional approaches have been generalized to conversion matrices relating excitation and response signals at different frequencies. This approach is described for example in A. Cidronali et al., “Extraction of Conversion Matrices for P-HEMTs based on Vectorial Large-Signal Measurements”, IEEE MTT-S Digest, pp 777-780, 2003 and in Dylan F. Williams et al., “Scattering-Parameter Models and Representations for Microwave Mixers”, IEEE Transactions on Microwave Theory and Techniques, Vol. 53, No. 1, pp 314-321, January 2005.

Although the above approach may have some practical value, the phase of the conversion matrix elements is no longer time invariant when the frequencies of the excitation and response signals differ. Furthermore, linearization of the conversion matrix elements neglects the inherent non-linear nature of the behavior of the device under test and makes the approach unsuitable for accurate device characterization.

It is an object of the present invention to provide a method and arrangement for determining non-linear behavior of a device under test, by means of which the non-linear behavior can be more accurately characterized, modeled and understood.

The above object is achieved by a method as defined in claim 1 and by an arrangement as defined in claim 9.

Accordingly, the proposed calibration, correction and extraction provides the advantage that the extracted parameters are valid over a large range of operating conditions, rather than representing a linearized conversion coefficient in a particular operating point, which makes them much more suitable for characterizing non-linear behavior.

The correction preferably may be adapted to correct for harmonics generated in at least one of a signal source of the test signal and measuring devices used for measuring. Thereby, efficient correction can be achieved.

Furthermore, the correction can be performed by analyzing harmonics measured under at least one of different load conditions and different tuner settings. This provides a straight forward way to determine required corrections. In particular, the correction may be based on at least one of scattering parameters S₂₁₁ and S₂₁₁₁ of at least one of the signal source in forward and reverse direction and at least one of the measuring devices. The performance may be improved by performing the correction also based on at least one additional parameter selected from scattering parameters S₂₁₂ and S₂₂₂ of the signal source.

The correction parameters may be extracted from an over-determined set of equations using a least square residuals fitting. Similarly, the desired non-linear device scattering or admittance parameters can be extracted from an over-determined set of equations using a least square residuals fitting.

As an optional extension, the signal generating means may be arranged for applying test signals at different excitation frequencies to the device, wherein mixer means are provided for generating reference signals at sum or difference frequencies supplied to reference receivers, and wherein the calibration, correction and extracting means are arranged to determine the non-linear behavior of the device for a plurality of non-harmonically related excitation frequencies.

The present invention will now be described based on a preferred embodiment with reference to the accompanying drawings, in which:

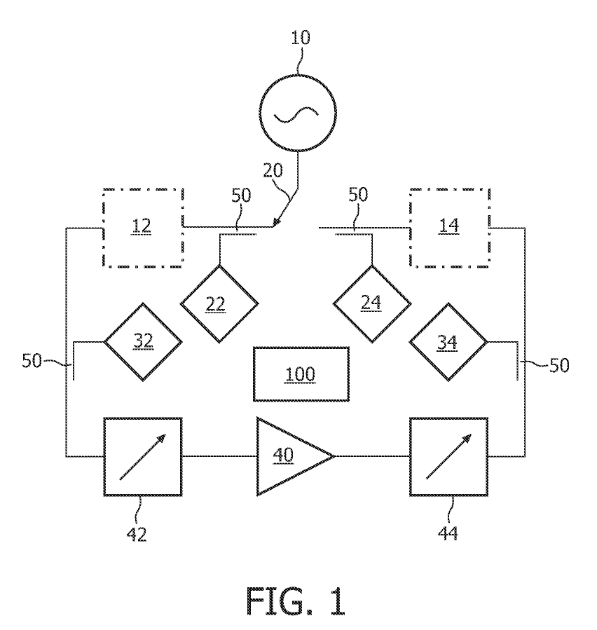

FIG. 1 shows a schematic block diagram of an arrangement according to the preferred embodiment;

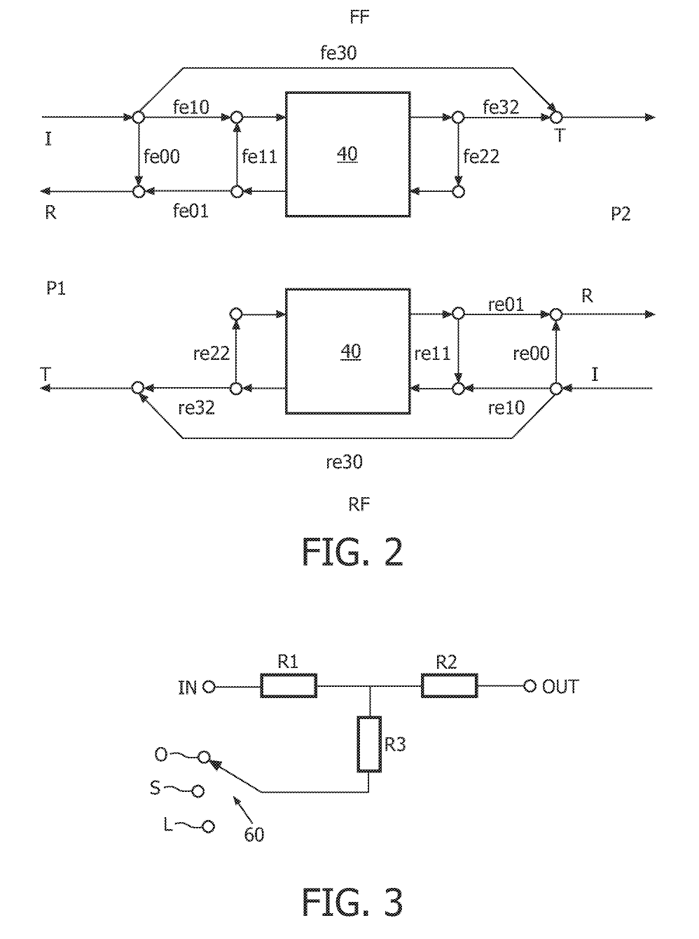

FIG. 2 shows an error model for a connection between a device under test and a network analyzer according to the preferred embodiment;

FIG. 3 shows tuner means for use in the arrangement according to the preferred embodiment;

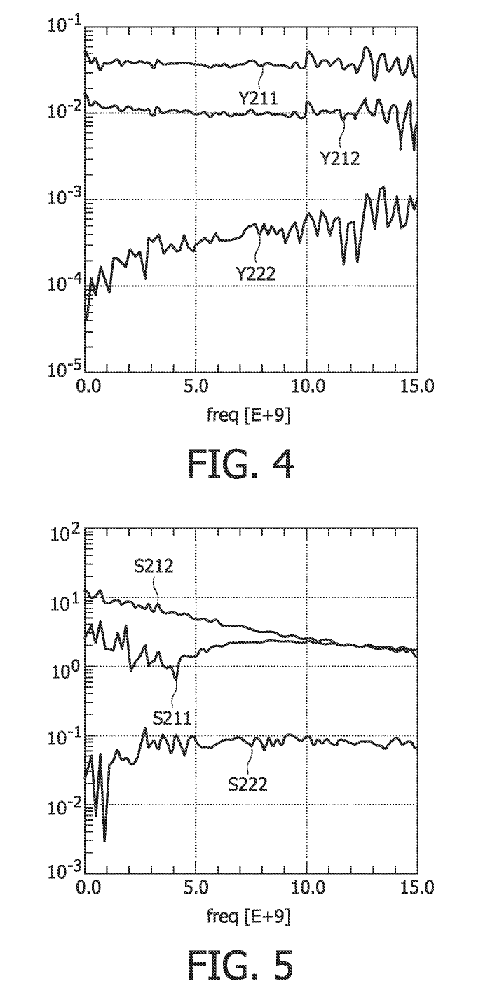

FIG. 4 shows a diagram of absolute values of Y-parameters determined over frequency with a method according to the preferred embodiment; and

FIG. 5 shows a diagram of absolute values of S-parameters determined over frequency with a method according to the preferred embodiment.

In the following, the preferred embodiment will be described in connection with a four-sampler network analyzer.

FIG. 1 shows an arrangement required for determining or characterizing the non-linear behavior of RF and microwave devices according to the preferred embodiment.

In the preferred embodiment, the relations between the signals entering the device under test (DUT) 40 and emitted from the DUT 40 are taken from Volterra theory in terms of (generalized) S-parameters as expressed in the following equations:

bᵢ=Sᵢⱼaⱼ

for the linear behavior, where aⱼ represents the incident signal at frequency f₁ and port j and b, represents the emitted signal at frequency f₁ and port i, and:

bᵢ=Sᵢⱼₖaⱼaₖ

for (second order) up-conversion, where aₖ represents the incident signal at frequency f₂ and port k, aⱼ represents the incident signal at frequency f₁ and port j and b, represents the emitted signal at the sum frequency f₁+f₂ and port i, and:

bᵢ=Sᵢⱼₖaⱼaₖ

for (second order) down-conversion, where aₖ represents the incident signal at frequency f₂ and port k, aᵢ represents the incident signal at frequency f₁ and port j and b, represents the emitted signal at the difference frequency f₁−f₂ and port i, and:

bᵢ=Sᵢⱼₖₗaⱼaₖaₗ

for (third order) up-conversion, where aₗ represents the incident signal at frequency f₃ and port 1, where aₖ represents the incident signal at frequency f₂ and port k, aⱼ represents the incident signal at frequency f₁ and port j and b, represents the emitted signal at the sum frequency f₁+f₂+f₃ and port i, and similar expressions apply for (third order) down conversion where the complex conjugate of an incident signal has to be taken whenever its frequency is subtracted from the others.

It is apparent that for each emitted frequency the number of (generalized) S-parameters is:

n=m^{(o+1)}

where m represents the number of ports of the DUT 40 and o represents the order of the (non-) linear behavior, which in turn can be recognized from the number of indices associated with the generalized S-parameters. Furthermore the phase of all higher order S-parameters defined here is time invariant, which is an important advantage.

For device modeling purposes, admittance (Y) parameters are preferred over S-parameters. The generalization towards non-linear Y-parameters follows a similar path as outlined above, replacing the emitted signals b by small signal currents i, and excitation signals a by small signal voltages v.

The arrangement required for characterizing these non-linear S or Y parameters can be simplified considerably if the procedure is limited to exciting the DUT 40 at a single frequency and only measure the signals emitted at this frequency and harmonics of this frequency. The second harmonic currents for instance can now be related to the excitation voltages at the fundamental frequency as:

i₁=Y₁₁₁v₁²+Y₁₁₂v₁v₂+Y₁₂₂v₂²

i₂=Y₂₁₁v₁²+Y₂₁₂v₁v₂+Y₂₂₂v₂²

Similarly the third harmonic currents can thus be related to the excitation voltages at the fundamental frequency as:

i₁=Y₁₁₁₁v₁³+Y₁₁₁₂v₁²+Y₁₁₂₂v₁v₂²+Y₁₂₂₂v₂³

i₂=Y₂₁₁₁v₁³+Y₂₁₁₂v₁²v₂+Y₂₁₂₂v₁v₂²+Y₂₂₂₂v₂³

It should be noted that although this notation may look similar to that used in the above mention prior art of Cidronali et al., the cross terms and the fact that the generalized Y-parameters are time invariant and are valid over a large range of operating conditions, rather than representing a linearized conversion coefficient in a particular operating point, make them much more suitable for characterizing non-linear behavior.

The arrangement shown in FIG. 1 is a four-sampler network analyzer. In this network analyzer, four receivers 32, 34, 22 and 24 coupled via respective couplers 50 can be programmed and controlled by a computer or processor device 100 to detect signals emitted at the harmonics of the signal source frequency. The arrangement furthermore contains tuner means 42, 44 for presenting different source and load impedances to the DUT 40 and may contain optional filters 12, 14 to improve spectral purity of the signals presented or applied to the DUT 40. The tuner means 42, 44 may as well be controlled by the processor device 100.

The arrangement can provide absolute signal powers measured at receiver 32 or 34, and the ratios of signals measured at the receiver pairs 32 and 22, 32 and 24, 34 and 22, 34 and 24 for both positions of a port switch 20, which selectively connects the output of a signal source 10 to an input branch or an output branch of the DUT 40. These signal ratios are complex figures also containing information on the phase difference between the measured signals of measuring receivers 32 or 34 and the reference signals of reference receivers 22 or 24. By combining the phase of these signal ratios with the absolute power levels, the complex signal waves b₁ and b₂ measured at the measuring receivers 32 and 34 can be reconstructed down to a constant phase difference. The signal source 10 of the arrangement is assumed to contain a sufficiently large amount of harmonic signal power to enable measurement of the complex signal waves at harmonic frequencies. By replacing the DUT 40 with conventional open, short, load, and thru calibration standards, the relation between the signal waves b₁ and b₂ emitted by the DUT 40 and those at the measuring receivers 32 and 34 can be determined. Similarly, the relation between the signal waves a₁ and a₂ incident on the DUT 40 and the signal power level of the signal source 10 can be determined.

FIG. 2 shows a schematic block diagram of an error model for the connection between the DUT 40 and the arrangement of the network analyzer of FIG. 1, to be used for the above determination. The upper portion of FIG. 2 shows a two-port forward flow diagram, and the lower portion shows a two-port reverse flow diagram. In both diagrams, incident signals I, reflected signals R and transmitted signals T are depicted as arrows at a first port P1 and a second port P2.

The procedures can be applied for all relevant settings of the tuner means 42, 44 and all fundamental and harmonic frequencies of interest. Furthermore, a correction for harmonics generated in the signal source 10 and the receivers 32, 34 can be performed. The procedure to apply this type of corrections is not known from previous art, but can be easily defined using the non-linear S-parameters.

In particular, the corrections can be found by analyzing the harmonics measured on the open, short, load, and thru calibration standards (std) for different settings of the tuner means 42, 44 using:

bᵢ(f₂)={S_{211,src}_{_{—}}ⱼ(f₂)S_{ij,std}(f₂)+S_{211,rec}_{_{—}}ᵢ(f₁)S_{ij,std}(f₁)²}aⱼ(f₁)

Characterizing the S₂₁₁ and S₂₁₁₁ parameters of the signal source (src) 10 in forward and reverse configuration and of the receivers (rec) 32, 34 is sufficient to allow these corrections to be performed. Additional improvements are possible when the parameters S₂₁₂ and S₂₂₂ of the signal source 10 are also extracted and accounted for. These extractions are performed based on an over-determined set of equations using standard least square residuals fitting. With these corrections, the signals aⱼ incident on the DUT 40 and the signals bⱼ emitted from the DUT 40 at all settings of the tuner means 42, 44 and all fundamental and harmonic frequencies of interest can be derived.

The excitation voltages vⱼ and resulting currents iⱼ can now be determined from

vⱼ=(aᵢ+bⱼ)·\sqrt{50}

iⱼ=(aⱼ−bⱼ)/\sqrt{50}

In the arrangement according to the preferred embodiment, the 2^{nd} harmonic currents measured at the DUT 40 result from frequency doubling of the signal emitted by the signal source 10 and amplification of the second harmonic signal due to the S₂₁₁ of the signal source 10. The effect of the latter is corrected for by using the linear S-parameters measured at the second harmonic frequency. Second harmonic signals generated in the DUT 40 by mixing of the third harmonic with the fundamental frequency of the signal source 10 are usually sufficiently small to be neglected. Similarly the 3^{rd} harmonic currents measured at the DUT 40 as a result of frequency tripling of the signal emitted by the signal source 10 and amplification of the 3^{rd} harmonic signal due to the S₂₁₁₁ of the signal source 10. The effect of the latter is corrected for by using the linear S-parameters measured at the 3^{rd} harmonic frequency. Third harmonic signals generated in the DUT 40 by mixing second harmonic with the fundamental frequency of the signal source 10 might need to be included in the extraction for best accuracy. When needed, this is straight forward provided the DUT 40 has been measured at sufficient settings of the tuner means 42, 44.

FIG. 3 shows a schematic circuit diagram of an example of the tuner means 42, 44 at the input and output of the DUT 40. The circuits are composed of a resistive power splitter comprising resistors R1, R2 and R3, and a switching element 60 for selectively switching to three calibration standards, e.g. an open O, short S, and load L impedance standard.

Advantages of the preferred embodiment will now be illustrated by referring to a sample measurement obtained without filters 12, 14 on an n-MOS (Metal Oxide Semiconductor) transistor with 82 nm gate-length taken from an advances CMOS (Complementary MOS) process, and driven at Vg=0.7 and Vd=1.5. Although very lossy, the tuner means 12, 14 arranged as shown in FIG. 3 provide the advantage that they operate over a very large bandwidth. After applying the calibration and correction steps described before, second harmonic currents of the DUT 40 measured for forward and reverse excitation for the nine different combinations of settings of the input and output tuner means 42, 44 can now be related to the corresponding excitation voltages of the DUT 40 at the fundamental frequency using the previous equation:

i₁=Y₁₁₁v₁²+Y₁₁₂v₁v₂+Y₁₂₂v₃²

i₂=Y₂₁₁v₁²+Y₂₁₂v₁v₂+Y₂₂₂v₂²

This over-determined system of 36 equations for 6 unknowns is again solved using standard least square residuals fitting.

FIGS. 4 and 5 show the results over frequency for the second order Y-parameters and for the second order S-parameters, respectively. In particular, FIG. 4 shows a diagram of absolute values of some 2^{nd} order Y-parameters determined over frequency for the n-MOS transistor, and FIG. 5 shows a diagram of absolute values of some 2^{nd} order S-parameters determined over frequency for the n-MOS transistor.

It can be seen that the second order S and Y-parameters differ significantly from each other. Whereas the second order S-parameters show a significant dependence on frequency, the Y₂₁₁ and the Y₂₁₂ are virtually flat with frequency. In fact their magnitudes appear to correspond very well to half the derivatives of the transconductance (δi_{d}/δv_{g}) to the gate and drain voltages of the n-MOS transistor, respectively.

In conclusion, it has been shown that the method of and arrangement for determining or characterizing the non-linear behavior of RF and microwave devices described above provides significant improvement over the prior art, and allows this behavior to be more accurately characterized, modeled and understood.

The above processing involved in the described calibration, correction and extraction can be implemented by corresponding processing steps to be performed by the processor device 100, e.g., under control of a corresponding program routine.

Additionally, the described preferred embodiment can be enhanced by providing an additional signal source or by arranging the signal source 10 so as to apply a test signal to the DUT 40 at additional excitation frequencies. Then, test signals at different excitation frequencies can be applied to different device terminals via the switching element 20 and measured by the receivers 32, 34 via the respective couplers 50. Furthermore, mixer circuits (not shown) may be provided to generate reference signals at sum or difference frequencies required at the reference receivers 22, 24. An extended calibration, correction and extracting processing can then be performed by the processor device 100 to determine the non-linear behavior of the DUT 40 for a plurality of non-harmonically related excitation frequencies.

In summary, a method of and arrangement for determining non-linear behavior of the DUT 40 has been described, wherein the DUT 40 is excited by a test signal on relevant device terminals under different termination conditions and the emitted signals at the fundamental and harmonic frequencies are measured at the relevant device terminals. Then, calibration measurements taken on calibration standards of known impedance and linearity are performed to derive parameters needed to correct the raw data read by the measurement for cable loss and delay and for non-linear behavior of the measurement system. Finally, non-linear scattering or admittance parameters are extracted from the error corrected measurements taken at different excitation and termination conditions.

Finally but yet importantly, it is noted that the term “comprises” or “comprising” when used in the specification including the claims is intended to specify the presence of stated features, means, steps or components, but does not exclude the presence or addition of one or more other features, means, steps, components or group thereof. Further, the word “a” or “an” preceding an element in a claim does not exclude the presence of a plurality of such elements. Moreover, any reference sign does not limit the scope of the claims.

1. A method of determining non-linear behavior of a device under test, said method comprising the steps of:
a). applying a test signal to said device at relevant terminals of said device under different termination conditions;
b). measuring signals obtained at said relevant terminals of said device at a fundamental frequency and at least one harmonic frequency of said test signal;
c). performing a calibration measurement to obtain correction parameters;
d). using said correction parameters to correct raw data measured in said measuring step b) for effects not caused by said test device; and
e). extracting at least one of scattering or admittance parameters from said corrected raw data and using said extracted parameters to determine said non-linear behavior of said device.

2. A method according to claim 1, wherein said correction step d) is adapted to correct for harmonics generated in at least one of a signal source of said test signal and measuring devices used in said measuring step b).

3. A method according to claim 1, wherein said correction step d) comprises a step of analyzing harmonics measured in said measuring step b) under at least one of different load conditions and different tuner settings.

4. A method according to claim wherein said correction step d) is based on at least one of scattering parameters S₂₁₁ and S₂₁₁₁ of at least one of a signal source of said test signal in forward and reverse direction and at least one measuring device.

5. A method according to claim 4, wherein said correction step d) is based at least one additional parameter selected from scattering parameters S₂₁₂ and S₂₂₂ of said signal source.

6. A method according to claim 4, wherein said correction parameters are extracted from an over-determined set of equations using a least square residuals fitting.

7. A method according to claim wherein the desired non-linear device scattering or admittance parameters are extracted from an over-determined set of equations using a least square residuals fitting.

8. A method according to claim 1, wherein said device under test is a radio frequency or microwave device.

9. An arrangement for determining non-linear behavior of a device under test, said arrangement comprising:
signal generating means for applying a test signal to said device at relevant terminals of said device under different termination conditions;
measuring means for measuring signals obtained at said relevant terminals of said device at a fundamental frequency and at least one harmonic frequency of said test signal;
calibration means for performing a calibration measurement to obtain correction parameters;
correcting means for using said correction parameters to correct raw data measured by said measuring means for effects not caused by said test device; and
extracting means for extracting at least one of scattering or admittance parameters from said corrected raw data and using said extracted parameters to determine said non-linear behavior of said device.

10. An arrangement according to claim 9, wherein said signal generating means are arranged for applying test signals at different excitation frequencies to said device, wherein mixer means are provided for generating reference signals at sum or difference frequencies supplied to reference receivers, and wherein said calibration, correction and extracting means are arranged to determine said non-linear behavior of said device for a plurality of non-harmonically related excitation frequencies.
